(19) United States
(12) Patent Application Publication
(10) Pub. No.: US 2011/0201350 A1
(43) Pub. Date: Aug. 18, 2011

(54) PORTABLE ELECTRONIC DEVICE POSITIONING BASED ON IDENTIFIABLE ZONES PRESENTING REDUCED WIRELESS COMMUNICATION CONDITIONS

(75) Inventors: Saumitra Mohan Das, San Jose, CA (US); Ayman Fawzy Naguib, Santa Clara, CA (US); Andrew C. Blaich, Notre Dame, IN (US); Edward Thomas Lingham Hardie, Menlo Park, CA (US)

(73) Assignee: QUALCOMM Incorporated, San Diego, CA (US)

(21) Appl. No.: 12/857,309

(22) Filed: Aug. 16, 2010

Related U.S. Application Data
(60) Provisional application No. 61/285,509, filed on Dec. 10, 2009.

(51) Int. Cl. H04W 24/00

(52) U.S. Cl. 455/456.1

(57) ABSTRACT

Techniques are provided which may be implemented in various methods and/or apparatuses to allow a portable electronic device to at least estimate its current position while within or otherwise operatively associated with an operating environment that may have one or more identifiable zones that present a reduced wireless communication condition.

### RELATED APPLICATION

This patent application claims benefit of and priority to U.S. Provisional Patent Application 61/285,509, filed Dec. 10, 2009, titled “Method for Dead-Zone Fingerprinting”, and incorporated in its entirety by reference herein.

### BACKGROUND

1. Field

The subject matter disclosed herein relates to portable electronic devices, and more particularly to methods and apparatuses for use in a portable electronic device to support position estimation determination in a wireless operating environment.

2. Information

It is often useful to determine a position of a portable electronic device with reference to some location scheme. For example, some portable electronic devices may include a global positioning system (GPS) and/or other like satellite positioning system (SPS) receiver that is capable of determining a relative geographical position of the portable electronic device based on an applicable multiple signal-based position estimation process. For example, some portable electronic device, e.g., a mobile station, may be capable of estimating on its own or with network support, its relative location based on wireless signals received from wireless signal transmitting devices (e.g., base stations, access points, location beacons, etc.) using certain multiple signal-based position estimation processes.

There may, however, be situations wherein a portable electronic device for various reasons may be unable to receive the requisite wireless signals to support a given multiple signal-based position estimation process. Thus, a portable electronic device may move to a position wherein the requisite wireless signal transmissions are no longer available for use. For example, a portable electronic device may move into a zone that either lacks coverage in some manner (e.g., out of range of a transmitting device), and/or in which the wireless signals that may be available are attenuated and/or otherwise affected in some manner which precludes their use in a given multiple signal-based position estimation process.

It would be beneficial for a portable electronic device to estimate its current position at times when reduced wireless communications conditions prohibit and/or otherwise inhibit in some manner effective use of a multiple signal-based position estimation process.

### SUMMARY

In accordance with certain aspects, techniques are provided which may be implemented in various methods and/or apparatuses to allow a portable electronic device to at least estimate its current position while within or otherwise operatively associated with an operating environment that may have one or more identifiable zones that present a reduced wireless communication condition.

By way of example, a method may be provided for a portable electronic device to obtain current wireless communication environment information at a current position within an operating environment, and determine estimated current position information for the portable electronic device. Here, for example the estimated current position information may be determined based, at least in part, on the current wireless communication environment information and expected wireless communication environment information associated with the operating environment. For example, at least a portion of the expected wireless communication environment information may be associated with at least one identifiable zone that presents a reduced wireless communication condition within the operating environment.

In certain further examples, a method may include determining the estimated current position information based, at least in part, on one or more signals representing estimated previous position information associated with the portable electronic device, and/or the current wireless communication environment information may comprise wireless signaling signature information associated with a signal strength of at least one wireless signal transmitted within the operating environment.

In other example implementations, a method may include determining whether the reduced wireless communication condition is present which prohibits use of a multiple signal-based position estimation function based, at least in part, on the current wireless communication environment information. Here, for example, in response to determining that the reduced wireless communication condition is present, a method may include determining the estimated current position information based, at least in part, on the current wireless communication environment information without using a multiple signal-based position estimation function. Conversely, in some example implementations, a method may further include, in response to determining that the reduced wireless communication condition is not present, determining the estimated current position information based, at least in part, on the current wireless communication environment information using the multiple signal-based position estimation function (e.g., using trilateration, multilateration, triangulation, and/or other like).

In certain example implementations, a method may include determining that a reduced wireless communication condition is present based, at least in part, on the current wireless communication environment information identifying that less than a threshold value of different wireless signals are available for use by the portable electronic device at the current position within the operating environment. Here, for example, a threshold value may specify that at least a certain plurality of different wireless signals be available for use by the portable electronic device at the current position within the operating environment. In certain example implementations, a method may further include selectively establishing at least one threshold parameter for use in determining whether a wireless signal is available for use by the portable electronic device at the current position within the operating environment

In certain example implementations, current wireless communication environment information may comprise wireless signaling signature information associated with a plurality of receiving antennas of the portable electronic device. In certain example implementations, expected wireless communication environment information may comprise information associated with at least one wireless signal transmitting device capable of transmitting at least one wireless signal for use by the portable electronic device at the current position within the operating environment.

In certain example implementations, information associated with the at least one wireless signal transmitting device may comprise position information associated with the at least one wireless signal transmitting device, and/or signal related information associated with the at least one wireless signal for use by the portable electronic device.

In certain example implementations, current wireless communication environment information and/or expected wireless communication environment information may comprise wireless signaling signature information associated with one or more positions wherein the portable electronic device is capable of being located while within the operating environment.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an operating environment which at times may present one or more identifiable zones that present a reduced wireless communications condition to a portable electronic device, in accordance with an implementation.

FIG. 2 is a schematic block diagram illustrating certain features of an exemplary portable electronic device that may be a capable of estimating its location within an operating environment which at times may present one or more identifiable zones that present a reduced wireless communications condition, in accordance with an implementation.

FIG. 3 is a functional flow diagram illustrating certain features of an exemplary process that may be implemented in a portable electronic device that may be a capable of estimating its location within an operating environment which at times may present one or more identifiable zones that present a reduced wireless communications condition, in accordance with an implementation.

### DETAILED DESCRIPTION

In accordance with certain aspects of the present description, various techniques are provided which may be implemented in a portable electronic device to allow the device to at least estimate its current position while within or otherwise operatively associated with an operating environment that may have one or more identifiable zone(s) that present a reduced wireless communication condition for the portable electronic device within the operating environment. For example, an identifiable zone may take the form of a “dead-zone” or the like, wherein some of the wireless signals which may support certain positioning functions are either unavailable to the portable electronic device and/or otherwise unusable for such purposes.

By way of example, a portable electronic device may be capable of obtaining one or more signals (e.g., via a wireless interface) which represent in some manner current wireless communication environment information that is available to the portable electronic device at a current position within an operating environment. By way of example but not limitation, a received signal strength indicator (RSSI), a round trip time (RTT), and/or other like information may be used. The portable electronic device may also be capable of determining estimated current position information. For example, estimated current position information my be based, at least in part, on current wireless communication environment information, e.g., as experienced/received by the portable electronic device and expected wireless communication environment information associated with at least a portion of the operating environment, e.g., as estimated, predicted, previously measured, and/or otherwise determined in some way as possibly being experienced/received by the portable electronic device. Here, for example, some or all of the expected wireless communication environment information may be received and/or stored in memory and be associated with at least one identifiable zone that presents a reduced wireless communication condition within the operating environment.

In certain example implementations, the portable electronic device may also be capable of determining estimated current position information based, at least in part, on estimated previous position information associated with the portable electronic device. For example, one or more last known positions and/or other related historical position/movement information may be used to determine an estimated current position.

In certain example implementations, current wireless communication environment information may include wireless signaling signature information associated with a signal strength and/or other like identifiable aspect of one or more of the wireless signals being transmitted within the operating environment and/or otherwise available to the portable electronic device.

In certain further example implementations, a portable electronic device may be capable of identifying whether a reduced wireless communication condition is present. For example, a reduced wireless communication condition may be determined to be present if a multiple signal-based position estimation function and/or other like function may be unable to operate properly or effectively. This may be determined, for example, based, at least in part, on current wireless communication environment information. Thus, in response to identifying that a reduced wireless communication condition is present, a portable electronic device may be capable of determining estimated current position information based, at least in part, on a current wireless communication environment information without using a multiple signal-based position estimation function, for example, using the techniques provided herein. To the contrary, if a reduced wireless communication condition is not present, then in certain instances, a portable electronic device may determine all or part of the estimated current position information based, at least in part, on the current wireless communication environment information using the multiple signal-based position estimation function. By way of some non-limiting examples, a multiple signal-based position estimation function may include a trilateration position estimation function, a multilateration position estimation function, a triangulation position estimation function, and/or the like.

In certain example implementations, a portable electronic device may also be capable of determining that a reduced wireless communication condition is present based, at least in part, on a current wireless communication environment information identifying that less than a threshold value of different wireless signals are available for use by the portable electronic device at the current position within the current operating environment. For example, in some situations, a threshold value may specify that at least two or three, or perhaps more, different wireless signals be available for use by the portable electronic device at a current position within a current operating environment, else a reduced wireless communication condition may be present.

In certain example implementations, current wireless communication environment information may also include wireless signaling signature information associated with a plurality of receiving antennas of the portable electronic device. Thus, for example, antenna diversity and/or other potential capabilities associated with multiple antennas/elements may be exploited and/or otherwise considered and used in some of the techniques presented herein. By way of example but not limitation, a signature for a zone may identify that a given access point may be “dead” on a given antenna in a zone.

In certain example implementations, a portable electronic device may also be capable of selectively establishing at least one threshold parameter for use in determining whether a wireless signal is available for use by the portable electronic device at the current position. Here, for example, a threshold parameter may be established in advance and/or in some dynamic manner such as through user input/interaction and/or via other programmed processes.

In certain example implementations, expected wireless communication environment information may include information associated with at least one wireless signal transmitting device capable of transmitting at least one wireless signal for use by the portable electronic device at a current position. By way of example only, expected wireless communication environment information may include and/or otherwise be characterized by position information associated with a wireless signal transmitting device (e.g., an access point, or the like), and/or signal related information associated with a wireless signal for use by the portable electronic device (e.g., received from an access point, or the like).

In certain example implementations, current wireless communication environment information and/or expected wireless communication environment information may include wireless signaling signature information associated with one or more positions wherein the portable electronic device is capable of being located while within the operating environment. For example, a wireless signaling signature may specify certain wireless signals and/or certain aspects of such signals, and/or the absence of such signals, as expected and/or measured at certain positions within the operating environment.

In certain example implementations, an operating environment may be associated with a specific region, such as a specified bounded physically structured region, into, out of, and/or within, which a portable electronic device may be transported. For example, a building or portion thereof, a campus or portion thereof, and/or other like arrangement may be provided as a specified bounded physically structured region.

In certain example implementations, current wireless communication environment information may include wireless signal propagation time information that is associated with at least one wireless signal transmitted between a wireless signal transmitting device and the portable electronic device. Thus, for example, a portable electronic device may be capable of interacting with a wireless signal transmitting device and measuring or otherwise determining wireless signal propagation time information between the portable electronic device and the wireless signal transmitting device. By way of example but not limitation, a signature may identify an absence of ability to receive time information of sending a packet and receiving it back from an access point. Such a signature may be present along with a signature of signal strength, for example, and both may provide complementary but disjoint information useful in positioning.

In certain example implementations, a portable electronic device may be capable of receiving at least a portion of expected wireless communication environment information from at least one other electronic device. For example, a wireless signal transmitting device may provide all or part of the expected wireless communication environment information, and/or other wireless communication system device(s) may provide all or part of the expected wireless communication environment information.

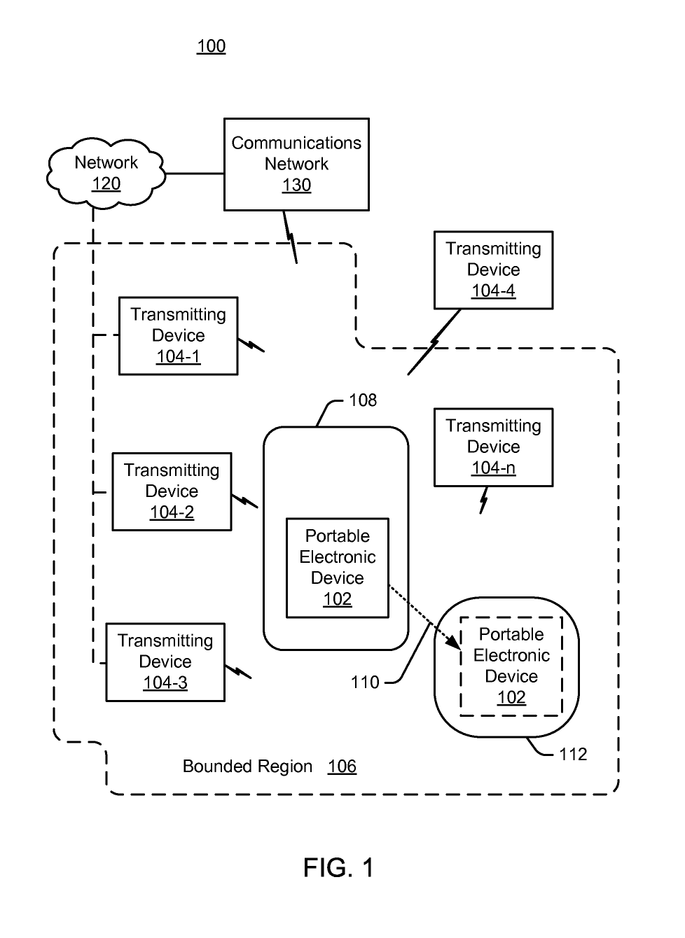

Reference is now made to FIG. 1, which is a schematic block diagram illustrating an operating environment 100, in accordance certain example implementations. As shown, an operating environment 100 may, for example, include one or more wireless signal transmitting devices 104 (shown as 104-1, 104-2, 104-3, 104-4, . . . , 104-n) operatively arranged within and/or otherwise about a bounded region 106. Bounded region 106 may, for example, represent a one or more buildings or other like structures and/or portion(s) thereof. Bounded region 106 may, for example, represent a campus comprising various buildings, open areas, pathways, streets, etc., and/or portion(s) thereof. These are but examples of a bounded region and claimed subject matter is not necessarily so limited. Bounded region 106 may, for example, be simply related to a service or coverage area associated with all or part of operating environment 100 and/or in particular reference to one or more wireless signal transmitting devices 104.

Wireless signal transmitting devices 104 may all be the same type of device, and/or represent different types of devices depending on the situation. By way of non-limiting example, one or more wireless transmitting devices 104 may include wireless network access points and/or other like devices which may not only transmit wireless signals but may also receive wireless signals. For example, wireless signal transmitting devices 104-1, 104-2 and 104-3 in FIG. 1 may comprise wireless access points which are also coupled to a network 120 and/or other communication and/or computing resources. Network 120 may, therefore, represent one or more communication and/or computing networks, services, resources, etc. In certain example implementations, network 120 (which may be optional) may include the Internet and/or other like computing and/or communication infrastructures. As illustrated, network 120 may be coupled to a communications network 130. Communications network (which may be optional) may include, for example, a cellular and/or other like wireless telecommunications system(s)/network(s). A communication network and/or certain wireless signal transmitting devices may, for example, comprise transmitting devices and/or other like computing devices which may act as repeaters to provide, extend, and/or otherwise enhance a coverage area for communications with mobile devices. For example, certain repeaters may provide for “femto-cell”, “pico-cell”, etc., operative regions of coverage.

As illustrated by the lightening bolt shaped lines in FIG. 1, the various wireless signal transmitting devices 104 and (optional) communications network 130 may be capable of transmitting wireless signals capable of being received by a portable electronic device 102. Such wireless signals may, for example, be provided specifically for use by at least one portable electronic device 102 to support positioning functions. Such wireless signals may, for example, be provided to at least one portable electronic device 102 for one or more other purposes and/or functions, such as, e.g., exchanging information (data, computer-implementable instructions, etc.) in the form of one or more signals (e.g., electrical signals).

Accordingly, there may be certain portions (zones) within bounded region 106 wherein a portable electronic device 102 is capable of receiving wireless signals and based, at least in part, thereon determine its current position based, at least in part, on such received wireless signals. For example, in FIG. 1, zone 108 is representative of a zone wherein a reduced wireless communication condition is not present. Thus, then in certain instances, portable electronic device 102 while in zone 108 may estimated its current position based, at least in part, on current wireless communication environment information using a multiple signal-based position estimation function.

It may be noted here that zone information may still have advantages despite not having a reduced communication condition. For example, in certain implementations, there may be only one area where all signals are present. Thus, sometimes a position estimate may have errors to due to a ranging error which may place a portable electronic device outside of a zone despite having no reduced communication. In such example situations, a signature, e.g., about the non-absence of any signal, may be used to better estimate a position of the portable electronic device.

There may be other identifiable zones, however, wherein a portable electronic device 102 may experience a reduced wireless communication condition. For example, as illustrated by dashed line 110, portable electronic device 102 may be transported from zone 108 to zone 112, wherein portable electronic device 102 may experience a reduced wireless communication condition might otherwise reduce the effectiveness of and/or possibly prohibit the use of a multiple signal-based position estimation function and/or the like. Thus, in accordance with certain aspects of the present description, in response to being in such a reduced wireless communication condition, portable electronic device 102 may be capable of determining its estimated current position based, at least in part, on current wireless communication environment information without using a multiple signal-based position estimation function and/or by further using one or more of the techniques provided herein.

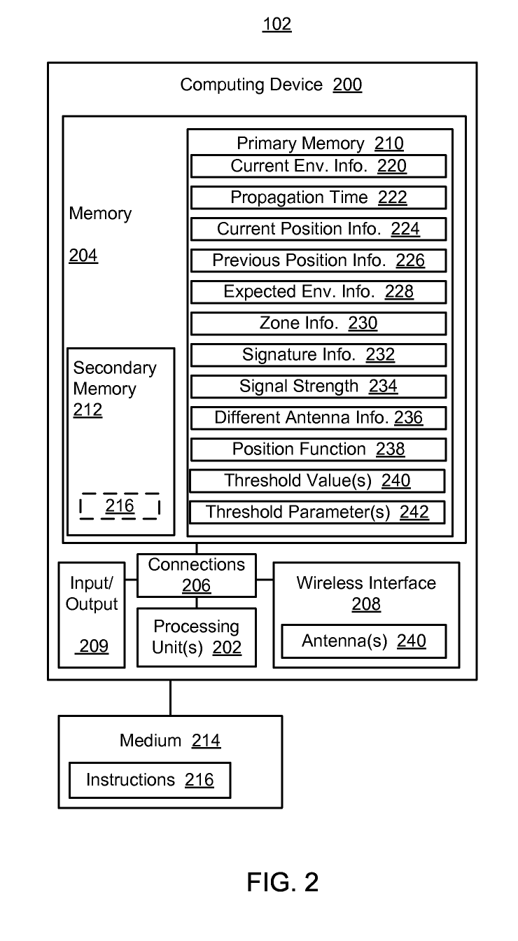

Reference is made next to FIG. 2, which is a schematic block diagram illustrating some features of a portable electronic device 102 comprising a computing device 200 in accordance with certain example implementations.

As shown, computing device 200 may include one or more processing units 202 and memory 204, which may be operatively coupled together via one more connections 206. Computing device 200 may also include one or more wireless interfaces 208, which may receive and/or transmit wireless signals, for example, using one or more antennas 240. Computing device 200 may further include one or more input and/or output mechanisms 209 and/or other like arrangements, which may be used to convey information to and/or receive information from a user. As illustrated, connections 206 may also operatively couple wireless interface 208 and/or input/output mechanisms 209 to one or both of processing unit(s) 202 and/or memory 204.

As further illustrated in FIG. 2 an article of manufacture, represented here by a computer readable medium 214, may be provided and accessed by processing unit(s) 202, for example. As such, in certain example implementations, the methods and/or apparatuses may take the form in whole or part of a computer readable medium 214 that includes computer implementable instructions 216 stored thereon, which if executed by at least one processing unit or other like circuitry enable the processing unit(s) 202 and/or the other like circuitry to perform all or portions of the techniques/processes as presented in the examples herein. Computer readable medium 214 may be representative of any data storage mechanism.

Processing unit(s) 202 may be implemented in hardware or a combination of hardware and software. Processing unit(s) 202 may be representative of one or more circuits configurable to perform at least a portion of a data computing procedure or process. By way of example but not limitation, processing unit(s) 202 may include one or more processors, controllers, microprocessors, microcontrollers, application specific integrated circuits, digital signal processors, programmable logic devices, field programmable gate arrays, and the like, or any combination thereof.

Memory 204 may be representative of any data storage mechanism. Memory 204 may include, for example, a primary memory 210 and/or a secondary memory 212. Primary memory 210 may include, for example, a random access memory, read only memory, etc. While illustrated in this example as being separate from processing unit(s) 202, it should be understood that at least a portion of a primary memory 210 may, for example, be provided within or otherwise co-located/coupled with processing unit(s) 202. Secondary memory 212 may, for example, include the same or similar type of memory as primary memory 210 and/or one or more data storage devices or systems, such as, for example, a disk drive, an optical disc drive, a tape drive, a solid state memory drive, a smart card, etc. In certain implementations, secondary memory 212 may be operatively receptive of, or otherwise configurable to couple to, computer readable medium 214.

Connections 206 are representative of one or more buses, lines, conductors, fibers, etc., that operatively couple the various circuits together and carry one or more electrical and/or other like signals there between. Input/output mechanism(s) 209 may, for example, include a keyboard, a keypad, a button, a touch screen, a pointer mechanism, a microphone, a camera, a motion sensor, a display, a speaker, a projector, and/or other like arrangements.

Wireless interface 208 may, for example, be capable of supporting one or more computing and communication services, such as, for example, telecommunication services, location/navigation services, and/or other like information and/or services with regard to portable electronic device 102. In certain example implementations, portable electronic device 102 may include a mobile station (MS) such as a cellular phone, a smart phone, a personal digital assistant, a portable computing device, a navigation unit, and/or the like or any combination thereof. In other example implementations, portable electronic device 102 may take the form of one or more integrated circuits, circuit boards, and/or the like that may be operatively enabled for use in another device.

With such examples and others in mind, wireless interface 208 may, for example, be enabled for use with various wireless communication networks such as a wireless wide area network (WWAN), a wireless local area network (WLAN), a wireless personal area network (WPAN), and so on. The terms “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example.

Antenna(s) 240 may, for example, include one or more antennas intended for specific communication related tasks/capabilities. In some example implementations, two or more antennas and/or antenna elements may be arranged and used to provide additional information regarding a received wireless signal. Here, for example, signal diversity and/or other like antenna-based capabilities may be employed to provide additional information regarding a transmitted wireless signal. Additionally, input/output mechanism(s) 209 may include one or more sensor mechanisms that may also provide information that may be considered separately and/or together in some manner with signal information relating to antenna(s) 240. For example, certain directional information (e.g., to a transmitting device) may be determined based, at least in part, on antenna diversity information and/or the like, and/or along with motion sensor information, magnetometer sensor information, and/or the like relating to a relative position/movement of the portable electronic device.

As further illustrated in FIG. 2, in certain situations and/or at certain times, primary memory 210 may have stored therein data as provided by, e.g., one or more signals (e.g., electrical signals) representing: current communication environment information 220, e.g., associated with a current position of the portable electronic device; propagation time information 222, e.g., associated with one or more wireless signals; estimated current position information 224, e.g., associated with the portable electronic device at or about a current time; estimated previous position information 226, e.g., associated with the portable electronic device at one or more earlier times; expected wireless communication environment information 228, e.g., associated with at least a portion of the operating environment that the portable electronic device may be located within as determined in advance and/or otherwise provided by at least one other electronic device; zone information 230, e.g., regarding one or more identifiable zones having or expected to present a reduced wireless communication condition to the portable electronic device (e.g., dead zones); wireless signaling signature information 232, e.g., as experienced at or about a current time by the portable electronic device at or about a current position in which either no useable wireless signals or some useable wireless signals are available for the portable electronic device; signal strength information 234, e.g., associated with at least one wireless signal received in some condition by the portable electronic device; different antenna related information 236, e.g., associated with one or more of a plurality of receiving antennas of the portable electronic device; a multiple signal-based position estimation function 238, e.g., a trilateration position estimation function, a multilateration position estimation function, a triangulation position estimation function, etc.; threshold value information 240, e.g., associated with a number of different wireless signals that may be desired to make use of multiple signal-based position estimation function 238; and/or threshold parameter information 242, e.g., for use in determining whether a wireless signal is available for use by the portable electronic device.

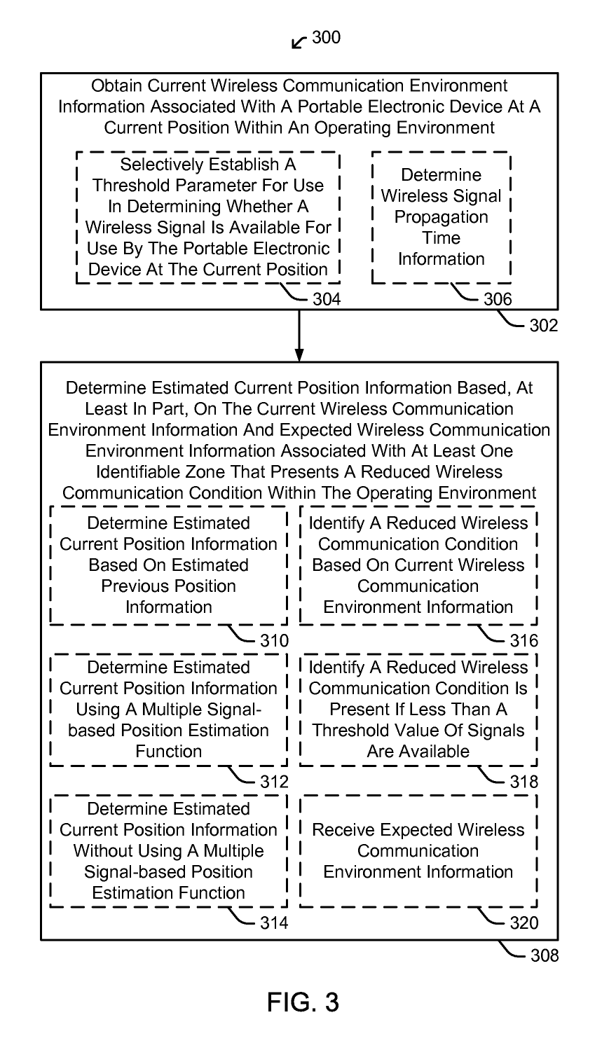

Attention is drawn next to FIG. 3, which is a flow diagram illustrating a process 300 that may be implemented in a portable electronic device 102, e.g., as in FIG. 1 and/or FIG. 2, in accordance with certain example implementations.

A block 302, current wireless communication environment information associated with a portable electronic device at a current position within an operating environment may be obtained. For example, a wireless receiver may be used to detect, receive and/or possibly acquire various wireless signals that may be available to the portable electronic device. In certain example implementations, wireless signal signature information may be established for the current position at or about a current time which identifies wireless signals and/or wireless signal transmitting devices that may be operatively identified and possibly available for use by portable electronic device.

In certain further example implementations at block 304, one or more threshold parameters may be selectively established for use in determining whether a wireless signal may be operatively identified and/or possibly available for use by the portable electronic device at the current position. For example, a threshold parameter may be established via user input and define, at least in part, a range of signal strengths and/or other measurable or identifiable metrics that may be employed to differentiate or otherwise characterize wireless signals and/or the absence of wireless signals. In certain example implementations, at block 306, wireless signal propagation time information may be determined in some manner and included in or otherwise used to affect at least a portion of the current wireless communication environment information. For example, wireless signal propagation time information may be used to determine an estimated distance or range between the portable electronic device and a transmitting device and such information may be included in or otherwise used to affect at least a portion of current wireless communication environment information.

At block 308, estimated current position information may be determined based, at least in part, on current wireless communication environment information and expected wireless communication environment information. Expected wireless communication environment information may, for example, be associated with at least one identifiable zone that presents a reduced wireless communication condition within the operating environment. At block 320, for example, all or part of expected wireless communication environment information may be received in advance and/or possibly in real time, from at least one other electronic device.

In certain example implementations, at block 310, estimated current position information may be determined based, at least in part, estimated previous position information. In certain example implementations, at block 312, estimated current position information may be determined based, at least in part, on current wireless communication environment information using a multiple signal-based position estimation function if a reduced wireless communication condition is not present. In certain example implementations, at block 314, estimated current position information may be determined based, at least in part, on current wireless communication environment information without using a multiple signal-based position estimation function if a reduced wireless communication condition is present.

In certain example implementations, at block 316, a reduced wireless communication condition may be identified as being present at the current position of the portable electronic device based, at least in part, on the current wireless communication environment information. At block 318, for example, a reduced wireless communication condition may be determined to be present based, at least in part, on the current wireless communication environment information identifying that less than a threshold value of different wireless signals are available for use by the portable electronic device.

Thus, as illustrated in the example implementations herein, a portable electronic device may be capable of estimating its current position despite being in zone that has or presents a reduced wireless communication condition. Indeed, as shown, by identifying one or more such zones in the expected wireless communication environment information that is used by the portable electronic device, such identifiable zone(s) while possibly being devoid of wireless signals and/or having limited numbers of usable wireless signals may nonetheless serve as information useful in determining an estimated current position of the portable electronic device within an operating environment. With this in mind, some additional non-limiting examples are presented below to further illustrate certain aspects of these techniques.

In certain example implementations, methods and/or apparatuses may be provided which allow a portable electronic device to employ dead zone fingerprinting Wi-Fi based positioning capabilities, wherein dead zones may be used as or like landmarks for positioning. In certain example implementations, user input or other like functions may be used to further improve such dead zone fingerprints, e.g., via dynamic noise level adjustments controlled using certain threshold parameters. In certain example implementations, antenna related information (e.g., signal to noise (SNR) information, etc.) may be used to further improve dead zone fingerprints.

As described in some of the examples herein, wireless signal signature information may identify in some manner the wireless signals and/or wireless signals transmitting devices that are currently available to the portable electronic device. For example, a wireless signal signature may identify those access points (APs) of a Wi-Fi network that may be “seen” and those which cannot be “seen” for a given or certain position(s) and/or region(s) of an operating environment which may be used in some manner to estimate a current position of the portable electronic device within the operating environment.

Thus, with regard to block 302 of FIG. 3, a process may include obtaining wireless signal signature information as follows. Assuming that there are six access points (numbered 104-1 through 104-6) available and that only Access Points 104-1, 104-2 and 104-3 (each of which are unique) can be seen out of a possible six APs at a particular location (LCI (location context identifier)), the resulting signature inputted into a Dead Zone (DZ) process would be: 111000, where AP 104-1 is at the far left and AP 104-6 is at the far right of the example bitmap signature. Here, for example, “1”'s in the bitmap represent that an AP that can be seen (e.g., at a certain RSSI meeting a threshold parameter, if RSSI is available, etc.) and “0”'s in the bitmap represent that an AP cannot be seen (e.g., at a certain RSSI failing a threshold parameter, etc.). For example, a similar approach may be taken for storing a signature for

RTT where ‘1’ represents an ability to obtain a round trip time.

At block 308 of FIG. 3, for example, the resulting wireless signal signature information may be compared to and/or otherwise processed along with signature information that may be provided in and/or determined from the expected wireless communication environment information for one or more specific position(s) and/or region(s)/zone(s). Thus, in certain instances, current wireless signal signature information may “match” and/or otherwise be determined to be similar enough to similar signature information in the expected wireless communication environment information to lead to a determination that the portable electronic device may be currently positioned at, near and/or within such specific position(s) and/or region(s)/zone(s). For example, based on “matching” signature information, it may be determined that the portable electronic device may be currently located at or about a position associated with (x, y) coordinates (and/or other like position indicators) that make up or otherwise related to a dead zone boundary. By way of further example but not limitation, one or more various matching functions may be used. For example, a number of digits at which a signature matches may be considered. Thus, for example between 111000 and 110000 a match value may be deemed to be five since five digits match. Another matching function may, for example, take all the zeros and see how many of them match up. Thus, in the above example, one may ignore digits that have 1 in both signatures, in which case the match value would be three.

In certain example implementations, a last known good position (LKGP) and/or the like, e.g., as provided in the previous estimated position information, may be used to further assist in determining the current position of the portable electronic device. For example, in certain implementations, a previous position and/or other movement information relating to the device may be used to place the device near a particular dead zone or among multiple dead zones and/or otherwise be used in some manner to better fix or estimate a current position of the portable electronic device.

In certain example implementations, a process, such as process 300 at block 308, may logically draw or otherwise consider a convex hull around the x, y, and possibly z coordinates (and/or the like) that describe a dead zone (e.g., a zone with the same signature for absence of signal information) in order to draw or otherwise consider a region on a corresponding map for the current LCI. Such a convex hull drawing technique may, for example, employ a line-sweeping algorithm and/or the like. The hull, once constructed may, for example, be used to fix a portable electronic device to a particular region within a dead-zone (e.g., upper or lower, etc.). Having more accurate wireless signature information may, for example, allow for fixing or estimating a portable electronic device to a sub-hull within a main or larger convex hull in certain instances, and/or otherwise refine an estimated position for the portable electronic device.

In certain example implementations, process 300 may include storing a bit vector about presence or absence of signal information, e.g., such as RSSI or RTT at/for various points in an area. In certain example implementations, process 300 may include clustering points with same and/or similar signatures, e.g., using a convex hull and/or the like to define a zone with the same/similar signature.

In certain example implementations, process 300 may include matching portable electronic device signatures with above stored signatures to find (a closest) matching zone(s).

In certain instances, a portable electronic device which may know its position accurately from some other method may upload information to one or more other computing devices for use in creating and/or maintaining a signature database, and/or the like.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature and/or example. Furthermore, the particular features, structures, or characteristics may be combined in one or more examples and/or features.

As used herein, a portable electronic device, e.g., also referred to as a mobile station (MS) or mobile device, refers to a device such as a cellular or other wireless communication device, personal communication system (PCS) device, personal navigation device (PND), Personal Information Manager (PIM), Personal Digital Assistant (PDA), laptop, netbook, smartbook, tablet or other suitable device which is capable of receiving wireless communication and/or navigation signals. The term “portable electronic device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “portable electronic device” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “portable electronic device.”

The methodologies described herein may be implemented by various means depending upon the application. For example, these methodologies may be implemented in hardware, firmware, software, or any combination thereof. For an implementation involving hardware, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

For an implementation involving firmware and/or software, the functions may be stored as one or more instructions or code on a computer-readable medium. Examples include computer-readable media encoded with a data structure and computer-readable media encoded with a computer program. Computer-readable medium may take the form of an article of manufacture. Computer-readable medium includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “generating”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising: with a portable electronic device:
obtaining one or more signals representing current wireless communication environment information associated with said portable electronic device at a current position within an operating environment; and
determining one or more signals representing estimated current position information for said portable electronic device based, at least in part, on said current wireless communication environment information and one or more signals representing expected wireless communication environment information associated with said operating environment, wherein at least a portion of said expected wireless communication environment information is associated with at least one identifiable zone that presents a reduced wireless communication condition within said operating environment.

2. The method as recited in claim 1, further comprising:
determining said estimated current position information based, at least in part, on one or more signals representing estimated previous position information associated with said portable electronic device.

3. The method as recited in claim 1, wherein said current wireless communication environment information comprises one or more signals representing:
wireless signaling signature information associated with a signal strength of at least one wireless signal transmitted within said operating environment.

4. The method as recited in claim 1, further comprising:
determining whether said reduced wireless communication condition is present which prohibits use of a multiple signal-based position estimation function based, at least in part, on said current wireless communication environment information; and
in response to determining that said reduced wireless communication condition is present, determining said estimated current position information based, at least in part, on said current wireless communication environment information without using a multiple signal-based position estimation function.

5. The method as recited in claim 4, further comprising:
in response to determining that said reduced wireless communication condition is not present, determining said estimated current position information based, at least in part, on said current wireless communication environment information using said multiple signal-based position estimation function.

6. The method as recited in claim 4, wherein said multiple signal-based position estimation function comprises at least one of:
a trilateration position estimation function,
a multilateration position estimation function, and/or
a triangulation position estimation function.

7. The method as recited in claim 1, further comprising:
determining that said reduced wireless communication condition is present based, at least in part, on said current wireless communication environment information identifying that less than a threshold value of different wireless signals are available for use by said portable electronic device at said current position within said operating environment.

8. The method as recited in claim 7, wherein said threshold value specifies that at least three different wireless signals be available for use by said portable electronic device at said current position within said operating environment.

9. The method as recited in claim 1, wherein said current wireless communication environment information comprises one or more signals representing:
wireless signaling signature information associated with a plurality of receiving antennas of said portable electronic device.

10. The method as recited in claim 1, further comprising:
selectively establishing one or more signals representing at least one threshold parameter for use in determining whether a wireless signal is available for use by said portable electronic device at said current position within said operating environment.

11. The method as recited in claim 1, wherein said expected wireless communication environment information comprises one or more signals representing:
information associated with at least one wireless signal transmitting device capable of transmitting at least one wireless signal for use by said portable electronic device at said current position within said operating environment.

12. The method as recited in claim 11, wherein said information associated with said at least one wireless signal transmitting device comprises one or more signals representing at least one of:
position information associated with said at least one wireless signal transmitting device, and/or
signal related information associated with said at least one wireless signal for use by said portable electronic device.

13. The method as recited in claim 1, wherein at least one of said current wireless communication environment information and/or said expected wireless communication environment information comprises one or more signals representing:
wireless signaling signature information associated with one or more positions wherein said portable electronic device is capable of being located while within said operating environment.

14. The method as recited in claim 1, wherein said operating environment is associated with a specified bounded physically structured region into, out of, and/or within, which said portable electronic device is capable of being transported.

15. The method as recited in claim 1, wherein said current wireless communication environment information comprises one or more signals representing:
wireless signal propagation time information associated with at least one wireless signal transmitted between a wireless signal transmitting device and said portable electronic device.

16. The method as recited in claim 15, further comprising:
determining one or more signals representing said wireless signal propagation time information.

17. The method as recited in claim 1, further comprising:
receiving one or more signals representing at least a portion of said expected wireless communication environment information from at least one other electronic device.

18. The method as recited in claim 1, further comprising:
storing at least a portion of wireless signaling signature information as a bit vector identifying a presence or an absence of signaling information at various points in an area.

19. The method as recited in claim 18, further comprising:
clustering points with like wireless signaling signature information using a convex hull to define said at least one identifiable zone.

20. The method as recited in claim 1, further comprising:
matching wireless signaling signature information with stored wireless signaling signature information to identify a matching zone.

21. An apparatus for use in a portable electronic device, the apparatus comprising:
means for obtaining current wireless communication environment information associated with said portable electronic device at a current position within an operating environment; and
means for determining estimated current position information for said portable electronic device based, at least in part, on said current wireless communication environment information and expected wireless communication environment information associated with said operating environment, wherein at least a portion of said expected wireless communication environment information is associated with at least one identifiable zone that presents a reduced wireless communication condition within said operating environment.

22. The apparatus as recited in claim 21, further comprising:
means for determining said estimated current position information based, at least in part, on estimated previous position information associated with said portable electronic device.

23. The apparatus as recited in claim 21, wherein said current wireless communication environment information comprises:
wireless signaling signature information associated with a signal strength of at least one wireless signal transmitted within said operating environment.

24. The apparatus as recited in claim 21, further comprising:
means for determining whether said reduced wireless communication condition is present which prohibits use of a multiple signal-based position estimation function based, at least in part, on said current wireless communication environment information; and
means for determining said estimated current position information, in response to determining that said reduced wireless communication condition is present, based, at least in part, on said current wireless communication environment information without using a multiple signal-based position estimation function.

25. The apparatus as recited in claim 24, further comprising:
means for determining said estimated current position information, in response to identifying that said reduced wireless communication condition is not present, based, at least in part, on said current wireless communication environment information using said multiple signal-based position estimation function.

26. The apparatus as recited in claim 21, further comprising:
means for determining wireless signaling signature information associated with a signal strength of at least one wireless signal transmitted in said operating environment.

27. The apparatus as recited in claim 21, further comprising:
means for determining wireless signaling signature information associated with a plurality of receiving antennas of said portable electronic device.

28. The apparatus as recited in claim 21, further comprising:
means for determining that less than a threshold value of different wireless signals are available for use by said portable electronic device at said current position within said operating environment.

29. The apparatus as recited in claim 21, further comprising:
means for selectively establishing at least one threshold parameter for use in determining whether a wireless signal is available for use by said portable electronic device at said current position within said operating environment.

30. The apparatus as recited in claim 21, wherein said expected wireless communication environment information comprises:
information associated with at least one wireless signal transmitting device capable of transmitting at least one wireless signal for use by said portable electronic device at said current position within said operating environment.

31. The apparatus as recited in claim 21, wherein at least one of said current wireless communication environment information and/or said expected wireless communication environment information comprises:
wireless signaling signature information associated with one or more positions wherein said portable electronic device is capable of being located while within said operating environment.

32. The apparatus as recited in claim 21, wherein said expected wireless communication environment information comprises:
wireless signaling signature information associated with at least one position associated with at least one reduced wireless communication condition within which said portable electronic device is capable of being located while within said operating environment.

33. The apparatus as recited in claim 21, wherein said operating environment is associated with a specified bounded physically structured region into, out of, and/or within, which said portable electronic device is capable of being transported.

34. The apparatus as recited in claim 21, further comprising:
means for determining wireless signal propagation time information associated with at least one wireless signal transmitted between a wireless signal transmitting device and said portable electronic device.

35. The apparatus as recited in claim 21, further comprising:
means for receiving at least a portion of said expected wireless communication environment information from at least one other electronic device.

36. The apparatus as recited in claim 21, further comprising:
means for storing at least a portion of wireless signaling signature information as a bit vector identifying a presence or an absence of signaling information at various points in an area.

37. The apparatus as recited in claim 36, further comprising:
means for clustering points with like wireless signaling signature information using a convex hull to define said at least one identifiable zone.

38. The apparatus as recited in claim 21, further comprising:
means for matching wireless signaling signature information with stored wireless signaling signature information to identify a matching zone.

39. A portable electronic device comprising:
memory;
a wireless interface; and
at least one processing unit adapted to:
obtain current wireless communication environment information associated with said wireless interface at a current position within an operating environment; and
determine estimated current position information for said portable electronic device based, at least in part, on said current wireless communication environment information and expected wireless communication environment information associated with said operating environment and stored in said memory, wherein at least a portion of said expected wireless communication environment information is associated with at least one identifiable zone that presents a reduced wireless communication condition within said operating environment.

40. The portable electronic device as recited in claim 39, said at least one processing unit further adapted to:
determine said estimated current position information based, at least in part, on estimated previous position information associated with said portable electronic device.

41. The portable electronic device as recited in claim 39, wherein said current wireless communication environment information comprises:
wireless signaling signature information associated with a signal strength of at least one wireless signal received via said wireless interface.

42. The portable electronic device as recited in claim 39, said at least one processing unit further adapted to:
determine whether said reduced wireless communication condition is present which prohibits use of a multiple signal-based position estimation function based, at least in part, on said current wireless communication environment information; and
in response to determining that said reduced wireless communication condition is present, determine said estimated current position information based, at least in part, on said current wireless communication environment information without using a multiple signal-based position estimation function.

43. The portable electronic device as recited in claim 42, said at least one processing unit further adapted to:
in response to determining that said reduced wireless communication condition is not present, determine said estimated current position information based, at least in part, on said current wireless communication environment information using said multiple signal-based position estimation function.

44. The portable electronic device as recited in claim 39, said at least one processing unit further adapted to:
obtain wireless signaling signature information associated with a signal strength of at least one wireless signal received via said wireless interface.

45. The portable electronic device as recited in claim 39, said at least one processing unit further adapted to
obtain wireless signaling signature information associated with a plurality of receiving antennas of said wireless interface.

46. The portable electronic device as recited in claim 39, said at least one processing unit further adapted to:
determine that less than a threshold value of different wireless signals are available for use via said wireless interface at said current position within said operating environment.

47. The portable electronic device as recited in claim 39, said at least one processing unit further adapted to:
selectively establish at least one threshold parameter for use in determining whether a wireless signal is available for use by said portable electronic device at said current position within said operating environment.

48. The portable electronic device as recited in claim 39, wherein said expected wireless communication environment information comprises:
information associated with at least one wireless signal transmitting device capable of transmitting at least one wireless signal for use by said portable electronic device at said current position within said operating environment.

49. The portable electronic device as recited in claim 39, wherein at least one of said current wireless communication environment information and/or said expected wireless communication environment information comprises:
wireless signaling signature information associated with one or more positions wherein said portable electronic device is capable of being located while within said operating environment.

50. The portable electronic device as recited in claim 39, wherein said expected wireless communication environment information comprises:
wireless signaling signature information associated with at least one position associated with at least one reduced wireless communication condition within which said portable electronic device is capable of being located while within said operating environment.

51. The portable electronic device as recited in claim 39, wherein said operating environment is associated with a specified bounded physically structured region into, out of, and/or within, which said portable electronic device is capable of being transported.

52. The portable electronic device as recited in claim 39, said at least one processing unit further adapted to:
obtain wireless signal propagation time information associated with at least one wireless signal transmitted between a wireless signal transmitting device and said wireless interface.

53. The portable electronic device as recited in claim 39, said at least one processing unit further adapted to:
obtain at least a portion of said expected wireless communication environment information from at least one other electronic device via said wireless interface.

54. The portable electronic device as recited in claim 39, said at least one processing unit further adapted to:
store in said memory at least a portion of wireless signaling signature information as a bit vector identifying a presence or an absence of signaling information at various points in an area.

55. The portable electronic device as recited in claim 54, said at least one processing unit further adapted to:
cluster points with like wireless signaling signature information using a convex hull to define said at least one identifiable zone.

56. The portable electronic device as recited in claim 39, said at least one processing unit further adapted to:
match wireless signaling signature information with stored wireless signaling signature information to identify a matching zone.

57. An article comprising:
a computer readable medium having computer-implementable instructions stored thereon that are executable by one or more processing units in a portable electronic device, the computer-implementable instructions including:
code to obtain current wireless communication environment information associated with said portable electronic device at a current position within an operating environment; and
code to determine estimated current position information for said portable electronic device based, at least in part, on said current wireless communication environment information and expected wireless communication environment information associated with said operating environment, wherein at least a portion of said expected wireless communication environment information is associated with at least one identifiable zone that presents a reduced wireless communication condition within said operating environment.

58. The article as recited in claim 57, wherein said computer-implementable instructions further include:
code to determine said estimated current position information based, at least in part, on estimated previous position information associated with said portable electronic device.

59. The article as recited in claim 57, wherein said current wireless communication environment information comprises:
wireless signaling signature information associated with a signal strength of at least one wireless signal transmitted within said operating environment.

60. The article as recited in claim 57, wherein said computer-implementable instructions further include:
code to determine whether said reduced wireless communication condition is present which prohibits use of a multiple signal-based position estimation function based, at least in part, on said current wireless communication environment information; and
code to, in response to determining that said reduced wireless communication condition is present, determine said estimated current position information based, at least in part, on said current wireless communication environment information without using a multiple signal-based position estimation function.

61. The article as recited in claim 60, wherein said computer-implementable instructions further include:
code to, in response to determining that said reduced wireless communication condition is not present, determine said estimated current position information based, at least in part, on said current wireless communication environment information using said multiple signal-based position estimation function.

62. The article as recited in claim 57, wherein said computer-implementable instructions further include:
code to obtain wireless signaling signature information associated with a signal strength of at least one wireless signal transmitted in said operating environment.

63. The article as recited in claim 57, wherein said computer-implementable instructions further include:
code to obtain wireless signaling signature information associated with a plurality of receiving antennas of said portable electronic device.

64. The article as recited in claim 57, wherein said computer-implementable instructions further include:
code to determine that less than a threshold value of different wireless signals are available for use by said portable electronic device at said current position within said operating environment.

65. The article as recited in claim 57, wherein said computer-implementable instructions further include:
code to selectively establish at least one threshold parameter for use in determining whether a wireless signal is available for use by said portable electronic device at said current position within said operating environment.

66. The article as recited in claim 57, wherein said expected wireless communication environment information comprises:
information associated with at least one wireless signal transmitting device capable of transmitting at least one wireless signal for use by said portable electronic device at said current position within said operating environment.

67. The article as recited in claim 57, wherein at least one of said current wireless communication environment information and/or said expected wireless communication environment information comprises:
wireless signaling signature information associated with one or more positions wherein said portable electronic device is capable of being located while within said operating environment.

68. The article as recited in claim 57, wherein said expected wireless communication environment information comprises:
wireless signaling signature information associated with at least one position associated with at least one reduced wireless communication condition within which said portable electronic device is capable of being located while within said operating environment.

69. The article as recited in claim 57, wherein said operating environment is associated with a specified bounded physically structured region into, out of, and/or within, which said portable electronic device is capable of being transported.

70. The article as recited in claim 57, wherein said computer-implementable instructions further include:
code to obtain wireless signal propagation time information associated with at least one wireless signal transmitted between a wireless signal transmitting device and said portable electronic device.

71. The article as recited in claim 57, wherein said computer-implementable instructions further include:
code to obtain at least a portion of said expected wireless communication environment information from at least one other electronic device.

72. The article as recited in claim 57, wherein said computer-implementable instructions further include:
code to obtain at least a portion of wireless signaling signature information as a bit vector identifying a presence or an absence of signaling information at various points in an area.

73. The article as recited in claim 72, wherein said computer-implementable instructions further include:
code to cluster points with like wireless signaling signature information using a convex hull to define said at least one identifiable zone.

74. The article as recited in claim 57, wherein said computer-implementable instructions further include:
code to match wireless signaling signature information with stored wireless signaling signature information to identify a matching zone.
